(19) United States
(12) Patent Application Publication
(10) Pub. No.: US 2025/0354073 A1
(43) Pub. Date: Nov. 20, 2025

(54) PROCESS FOR PRODUCING KEROSENE AND/OR DIESEL FROM RENEWABLE SOURCES

(71) Applicant: SHELL USA, INC., Houston, TX (US)

(72) Inventors: Edmundo Steven VAN DOESBURG, Amsterdam (NL); Ronald Martijn DE DEUGD, Amsterdam (NL)

(21) Appl. No.: 18/871,273

(22) PCT Filed: Jun. 29, 2023
(86) PCT No.: PCT/US2023/069341

§ 371 Date: Dec. 3, 2024

Related U.S. Application Data
(60) Provisional application No. 63/357,697, filed on Jul. 1, 2022.

(30) Foreign Application Priority Data
Jul. 15, 2022 (EP) 22185225.4

(51) Int. Cl. C10G 65/12

(52) U.S. Cl. CPC C10G 65/12; C10G 2300/1003; C10G 2300/1011

(57) ABSTRACT

A process for improving yield of kerosene and/or diesel from a renewable feedstock involves hydrotreating a renewable feedstock and hydroisomerizing the hydrotreated liquid. The isomerized effluent is separated to produce an offgas stream, at least one fuel stream having a desired boiling point range, and a heavy fraction having a boiling point greater than the desired boiling point range. The heavy fraction is passed to a hydrocracking zone to produce a hydrocracked effluent. The hydro-cracked effluent is passed to the hydroisomerization zone.

### FIELD OF THE INVENTION

The present invention relates to the field of producing kerosene and/or diesel from renewable sources and, in particular, to a process for improving the yield of kerosene and/or diesel from renewable sources.

### BACKGROUND OF THE INVENTION

The increased demand for energy resulting from worldwide economic growth and development has contributed to an increase in concentration of greenhouse gases in the atmosphere. This has been regarded as one of the most important challenges facing mankind in the 21st century. To mitigate the effects of greenhouse gases, efforts have been made to reduce the global carbon footprint. The capacity of the earth's system to absorb greenhouse gas emissions is already exhausted. Accordingly, there is a target to reach net-zero emissions by 2050. To realize these reductions, the world is transitioning away from solely conventional carbon-based fossil fuel energy carriers. A timely implementation of the energy transition requires multiple approaches in parallel, including, for example, energy conservation, improvements in energy efficiency, electrification, and efforts to use renewable resources for the production of fuels and fuel components and/or chemical feedstocks.

Vegetable oils, oils obtained from algae, and animal fats are seen as renewable resources. Also, deconstructed materials, such as pyrolyzed recyclable materials or wood, are seen as potential resources.

Renewable materials may comprise materials such as triglycerides with very high molecular mass and high viscosity, which means that using them directly or as a mixture in fuel bases is problematic for modern engines. On the other hand, the hydrocarbon chains that constitute, for example, triglycerides are essentially linear and their length (in terms of number of carbon atoms) is compatible with the hydrocarbons used in/as fuels. Thus, it is attractive to transform triglyceride-comprising feeds in order to obtain good quality fuel components.

Petroleum-derived jet fuels inherently contain both paraffinic and aromatic hydrocarbons. In general, paraffinic hydrocarbons offer the most desirable combustion cleanliness characteristics for jet fuels. Challenges in using paraffinic hydrocarbons from renewable sources include higher boiling point, due to chain length, and higher freeze point. Solutions to these challenges include cracking to reduce chain length and/or isomerization to increase branching to improve cold flow properties.

In Marker et al. (U.S. Pat. No. 8,314,274, Nov. 20, 2012), a renewable feedstock is hydrogenated/hydrodeoxygenated and then isomerized and selectively hydrocracked to generate an effluent comprising branched paraffins. The effluent is separated to provide an overhead stream, an optional aviation product stream, a diesel stream and a stream having higher boiling points. A portion of the diesel boiling point range product is recycled to the isomerization and selective hydrocracking zone.

McCall et al. (U.S. Pat. No. 8,742,183, Jun. 3, 2014) relates to a process for production of aviation fuel from biorenewable feedstock, which is subjected to hydrogenation and deoxygenation to provide n-paraffins. Three embodiments are illustrated for subsequent steps of (i) isomerizing the n-paraffins and selectively cracking the isomerized effluent, (ii) selectively cracking the n-paraffins and isomerizing the cracked effluent, or (iii) subjecting the n-paraffins to a combined selective cracking and isomerization zone.

A challenge with isomerization and selective cracking schemes is a tension between maximizing product yield and meeting product specification.

Anumakonda et al. (U.S. Pat. No. 8,058,492, Nov. 15, 2011) describes a process for controlling production of transportation fuels from renewable feedstocks by determining a yield for diesel and aviation components, determining isomerization and selective hydrocracking conditions that results in the yields, hydrogenating and deoxygenating a renewable feedstock to produce n-paraffins, and isomerizing and selectively hydrocracking the n-paraffins. Diesel and aviation fuel components are fractionated under predetermined conditions. An overhead stream from the fractionator is further fractionated into LPG and naphtha streams. The naphtha stream is optionally recycled to the isomerization zone.

While Anumakonda et al. contemplates adjusting conditions to serve a predetermined yield, there is a limit to how effective the method can be when the deoxygenated product is subjected to the isomerization and selective cracking, as described therein. Markkanen et al. (EP2141217B1, 25 Mar. 2015; U.S. Pat. No. 9,005,429, Apr. 14, 2015) describe a process for making aviation fuel by a first stage hydrodeoxygenation of a biological feedstock, followed by a second stage isomerization of the resulting n-paraffins. Effluent from the second stage is separated in a fractionator to yield a gas, a gasoline fraction, an aviation fuel fraction, a diesel fraction, and a heavy fraction boiling at or above 200° C. (US′429) or 290° C. (EP′217B1).

In one embodiment of Markkanen et al., the heavy fraction is combined with the hydrodeoxygenated effluent and isomerizing the combined stream. In another embodiment, the heavy fraction is isomerized in a first section of the second stage and, after adding the hydrodeoxygenated effluent, the isomerized heavy fraction is isomerized with the hydrodeoxygenated effluent. Finally, in a third embodiment, the hydrodeoxygenated effluent and the heavy fraction are separately isomerized in a second stage and third stage isomerization, respectively. In the third embodiment of separate isomerization, the catalyst for the heavy fraction may be selected as promoting cracking.

There remains a need for improving the yield of kerosene and/or diesel from renewable sources.

### SUMMARY OF THE INVENTION

According to one aspect of the present invention, there is provided a process for improving yield of kerosene and/or diesel from a renewable feedstock, the process comprising the steps of: reacting a renewable feedstock in a hydrotreating zone under hydrotreating conditions sufficient to cause a hydrotreating reaction to produce a hydrotreated effluent; reacting the hydrotreated liquid in a hydroisomerization zone under hydroisomerization conditions to cause a hydroisomerization reaction to produce an isomerized effluent; separating the isomerized effluent to produce an offgas stream, at least one fuel stream having a desired boiling point range, and a heavy fraction having a boiling point greater than the desired boiling point range; reacting the heavy fraction in a hydrocracking zone under hydrocracking conditions to cause a hydrocracking reaction to produce a hydrocracked effluent; and passing the hydrocracked effluent to the hydroisomerization zone.

### BRIEF DESCRIPTION OF THE DRAWINGS

The process of the present invention will be better understood by referring to the following detailed description of preferred embodiments and the drawings referenced therein, in which:

FIG. 1 is a flow diagram illustrating one embodiment of the process of the present invention;

FIG. 2 is a flow diagram illustrating another embodiment of the process of the present invention; and

FIGS. 3A-3E are graphical representations of results of Examples presented herein.

### DETAILED DESCRIPTION OF THE INVENTION

The present invention provides a process for improving the yield of kerosene and/or diesel in the hydroprocessing of material from renewable sources. A renewable feedstock is hydrotreated. The hydrotreated effluent from the hydrotreating zone is passed to a hydroisomerization zone to produce an effluent that is fractionated to provide one or more desired product streams and a heavy fraction that is recycled. The heavy fraction is first selectively hydrocracked, and the hydrocracked effluent is then passed to the hydroisomerization zone.

It is generally understood that the hydroisomerization zone should be operated at high severity to maximize yield of isomerized product. However, when the hydroisomerization severity is high, there is an increased yield of undesirable and/or less valuable off-gas and/or naphtha. The inventors have surprisingly discovered that by operating at a lower hydroisomerization severity, the yield of heavy fraction is increased, and by passing the heavy fraction to a hydrocracking zone and then isomerizing the hydrocracked effluent, the yield of desirable isomerized product can be increased.

The process of the present invention is important for the energy transition and can improve the environment by producing low carbon energy and/or chemicals from renewable sources, and, in particular, from degradable waste sources, whilst improving the efficiency of the process.

A common challenge for processing renewable feedstocks to produce kerosene and/or diesel is the variability of renewable feedstocks. Variability of renewable feedstocks may include a change from one type of feedstock to another, for example, due to supply and/or markets, changes in feedstock quality and/or composition profile, seasonal variations, variations between sources of same feedstock, and the like. Reaction schemes, operating conditions, heat generation, process efficiency, product composition, and/or product yield may each be impacted by such variability. A further challenge for meeting product specifications is that the product component yields change as catalyst activity changes, and/or from start-of-run to end-of-run. The process of the present invention provides flexibility and robustness to allow for feedstock variability, changes in catalyst activity, and/or changes in desired products, while reducing energy consumption, operating costs, and/or carbon footprint. Further, the process of the present invention is more flexible in operating conditions and enables revamp of existing process schemes used for processing petroleum-derived feedstock.

Embodiments of process units for carrying out the method of the present invention are described below and/or illustrated in the drawings. For ease of discussion, additional equipment and process steps that may be used in a process for producing kerosene and/or diesel from a renewable feedstock are not shown. The additional equipment and/or process steps may include, for example, without limitation, pre-treaters, heaters, chillers, air coolers, heat exchangers, mixing chambers, valves, pumps, compressors, condensers, quench streams, recycle streams, slip streams, purge streams, reflux streams, and the like.

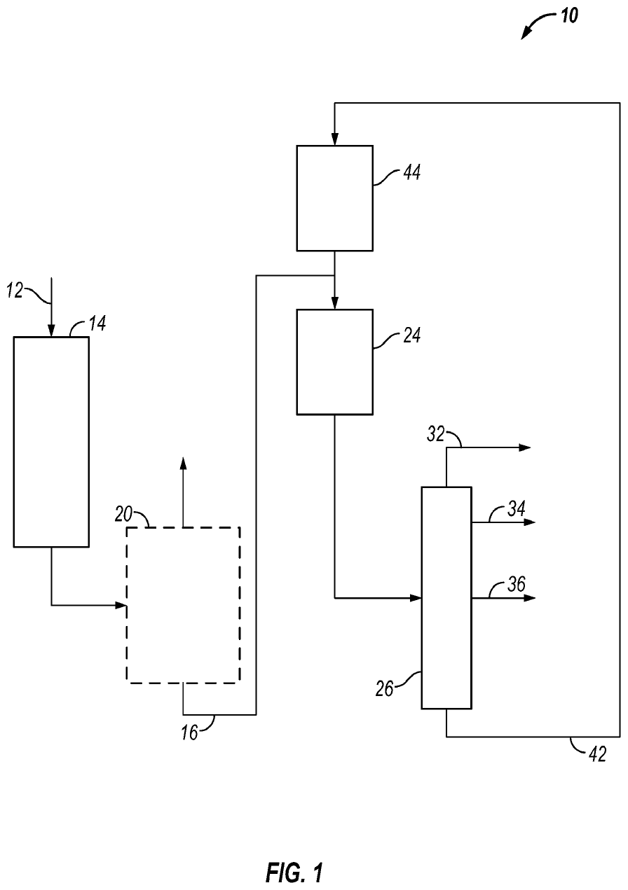

FIG. 1 illustrates one embodiment of the process of the present invention 10. A renewable feedstock 12 is reacted in a hydrotreating zone 14 to produce a hydrotreated effluent 16. Hydrogen may be combined with the renewable feedstock 12 stream before it is introduced the hydrotreating zone 14, co-fed with the renewable feedstock 12, or added to the hydrotreating zone 14 independently of the renewable feedstock 12. Hydrogen may be fresh and/or recycled from another unit in the process and/or produced in a HMU (not shown). In another embodiment, the hydrogen may be produced, for example, without limitation, by water electrolysis. The water electrolysis process may be powered by renewable energy (such as solar photovoltaic, wind or hydroelectric power) to generate green hydrogen, nuclear energy or by non-renewable power from other sources (grey hydrogen).

As used herein, the terms “renewable feedstock”, “renewable feed”, and “material from renewable sources” mean a feedstock from a renewable source. A renewable source may be animal, vegetable, microbial, and/or bio-derived or mineral-derived waste materials suitable for the production of fuels, fuel components and/or chemical feedstocks.

A preferred class of renewable materials are bio-renewable fats and oils comprising triglycerides, diglycerides, monoglycerides, free fatty acids, and/or fatty acid esters derived from bio-renewable fats and oils. Examples of fatty acid esters include, but are not limited to, fatty acid methyl esters and fatty acid ethyl esters. The bio-renewable fats and oils include both edible and non-edible fats and oils. Examples of bio-renewable fats and oils include, without limitation, algal oil, brown grease, canola oil, carinata oil, castor oil, coconut oil, colza oil, corn oil, cottonseed oil, fish oil, hempseed oil, jatropha oil, lard, linseed oil, milk fats, mustard oil, olive oil, palm oil, peanut oil, rapeseed oil, sewage sludge, soy oils, soybean oil, sunflower oil, pongamia oil, tall oil, tallow, used cooking oil, yellow grease, white grease, and combinations thereof.

Another preferred class of renewable materials are liquids derived from biomass and waste liquefaction processes. Examples of such liquefaction processes include, but are not limited to, (hydro) pyrolysis, hydrothermal liquefaction, plastics liquefaction, and combinations thereof. Renewable materials derived from biomass and waste liquefaction processes may be used alone or in combination with bio-renewable fats and oils.

The renewable materials to be used as feedstock in the process of the present invention may contain impurities. Examples of such impurities include, but are not limited to, solids, iron, chloride, phosphorus, alkali metals, alkaline-earth metals, polyethylene, and unsaponifiable compounds. If required, these impurities can be removed from the renewable feedstock before being introduced to the process of the present invention. Methods to remove these impurities are known to the person skilled in the art.

The process of the present invention is most particularly advantageous in the processing of feed streams comprising substantially 100% renewable feedstocks. However, in one embodiment of the present invention, renewable feedstock may be co-processed with petroleum-derived hydrocarbons. Petroleum-derived hydrocarbons include, without limitation, all fractions from petroleum crude oil, natural gas condensate, tar sands, shale oil, synthetic crude, and combinations thereof. The present invention is more particularly advantageous for a combined renewable and petroleum-derived feedstock comprising a renewable feed content in a range of from 30 to 99 wt. %. In one embodiment, the renewable feedstock is coprocessed with a heavy fraction from a petroleum refinery. For example, the petroleum-derived feedstock may be a heavy fraction from a gas oil unit.

In the hydrotreating zone 14, renewable feedstock 12 is reacted under hydrotreating conditions sufficient to cause a reaction selected from a hydrotreating reaction including, without limitation, hydrodeoxygenation, hydrodenitrogenation, hydrodesulphurization, hydrodearomatization, hydrogenation, hydrodemetallization, and combinations thereof. The reactions are preferably catalytic reactions, but may include non-catalytic reactions, such as thermal processing and the like. The hydrotreating zone 14 may be a single-stage or multi-stage. In the case of catalytic reactions, the hydrotreating zone 14 may be operated in a slurry, moving bed, fluidized bed, and/or fixed bed operation. In the case of a fixed bed operation, each reactor may have a single catalyst bed or multiple catalyst beds. The hydrotreating zone 14 may be comprised of a single reactor or multiple reactors. The hydrotreating zone 14 may be operated in a co-current flow, counter-current flow, or a combination thereof. Preferably, the hydrotreating zone 14 is operated in a co-current flow.

The catalyst may be the same or different throughout the hydrotreating zone 14. The hydrotreating zone 14 may comprise a single catalyst bed or multiple catalyst beds. The catalyst may be the same throughout the single catalyst bed, optionally there is a mixture of catalysts, or different catalysts may be provided in two or more layers in the catalyst bed. In an embodiment of multiple catalyst beds, the catalyst may be same or different for each catalyst bed.

In one embodiment, the hydrotreating zone 14 further comprises a hydrogenation catalyst in advance of the hydrotreating catalyst. The hydrogenation components may be used in bulk metal form, or the metals may be supported on a carrier. Active metals for hydrogenation include catalytically active metals of Group VIII and/or Group VIB, including, without limitation, Ni, Co, Mo, W, and combinations thereof. Preferably, the hydrogenation catalyst comprises Mo. Suitable carriers include refractory oxides, molecular sieves, and combinations thereof. Examples of suitable refractory oxides include, without limitation, alumina, amorphous silica-alumina, titania, silica, and combinations thereof. Examples of suitable molecular sieves include, without limitation, zeolite Y, zeolite beta, ZSM-5, ZSM-12, ZSM-22, ZSM-23, ZSM-48, SAPO-11, SAPO-41, ferrierite, and combinations thereof.

The hydrotreating catalyst may be any catalyst known in the art that is suitable for hydrotreating. Catalyst metals are often in an oxide state when charged to a reactor and preferably activated by reducing or sulphiding the metal oxide. Preferably, the hydrotreating catalyst comprises catalytically active metals of Group VIII and/or Group VIB, including, without limitation, Pd, Pt, Ni, Co, Mo, W, and combinations thereof. Hydrotreating catalysts are generally more active in a sulphided form as compared to an oxide form of the catalyst. A sulphiding procedure is used to transform the catalyst from a calcined oxide state to an active sulphided state. Catalyst may be pre-sulphided or sulphided in situ. Because renewable feedstocks generally have a low sulphur content, a sulphiding agent is often added to the feed to maintain the catalyst in a sulphided form.

Preferably, the hydrotreating catalyst comprises sulphided catalytically active metals. Examples of suitable catalytically active metals include, without limitation, sulphided nickel, sulphided cobalt, sulphided molybdenum, sulphided tungsten, sulphided CoMo, sulphided NiMo, sulphided MoW, sulphided NiW, and combinations thereof. A catalyst bed/zone may have a mixture of two types of catalysts and/or successive beds/zones, including stacked beds, and may have the same or different catalysts and/or catalyst mixtures. In case of such sulphided hydrotreating catalyst, a sulphur source will typically be supplied to the catalyst to keep the catalyst in sulphided form during the hydroprocessing step.

The hydrotreating catalyst may be sulphided in-situ or ex-situ. In-situ sulphiding may be achieved by supplying a sulphur source, usually H₂S or an H₂S precursor (i.e., a compound that easily decomposes into H₂S such as, for example, dimethyl disulphide, di-tert-nonyl polysulphide or di-tert-butyl polysulphide) to the hydrotreating catalyst during operation of the process. The sulphur source may be supplied with the feed, the hydrogen stream, or separately. An alternative suitable sulphur source is a sulphur-comprising hydrocarbon stream boiling in the diesel or kerosene boiling range that is co-fed with the feedstock. In addition, added sulphur compounds in feed facilitate the control of catalyst stability and may reduce hydrogen consumption.

The hydrotreating zone 14 may be operated as a single-stage process or a multi-stage process. In one preferred embodiment, the hydrotreating zone 14 is operated as a single-stage process, in a co-current mode with one or more fixed beds.

The product of the hydrotreating reaction is optionally directed to a separation zone 20 for separating the product of the hydrotreating reaction into a vapor phase effluent and a liquid hydrotreated effluent 16. Where the catalyst used for hydroisomerization has a noble metal, the separation zone 20 is provided to remove or at least substantially reduce components that poison or otherwise adversely impact the hydroisomerization catalyst. Where a non-noble metal is used for hydroisomerization, the separation zone 20 is optional.

When the separation zone 20 is included, the separation zone 20 has one or more separation units including, for example, without limitation, gas/liquid separators, including hot high- and low-pressure separators, intermediate high- and low-pressure separators, cold high- and low-pressure separators, high- and low-pressure strippers, integrated strippers, and combinations thereof. Integrated strippers include strippers that are integrated with hot high- and low-pressure separators, intermediate high- and low-pressure separators, cold high- and low-pressure separators. It will be understood by those skilled in the art that high-pressure separators operate at a pressure that is close to the hydrotreating zone 14 pressure, suitably 0-10 bar (0-1 MPa) below the reactor outlet pressure, while a low-pressure separator is operated at a pressure that is lower than a preceding reactor in the hydrotreating zone 14 pressure or a preceding high-pressure separator, suitably 0-15 barg (0-1.5 MPaG). Similarly, it will be understood by those skilled in the art that hot means that the hot-separator is operated at a temperature that is close to a preceding reactor in the hydrotreating zone 14 temperature, suitably sufficiently above water dew point (e.g., ≥10° C., preferably >20° C., above the water dew point) and sufficiently greater than salt deposition temperatures (e.g., ≥10° C., preferably ≥20° C., above the salt deposition temperature), while intermediate- and cold-separators are at a reduced temperature relative to the preceding reactor in the hydrotreating zone 14. For example, a cold-separator is suitably at a temperature that can be achieved via an air cooler. An intermediate temperature will be understood to mean any temperature between the temperature of a hot- or cold-separator.

In addition, the separation zone 20 may include one or more treating units including, for example, without limitation, a membrane separation unit, an amine scrubber, a pressure swing adsorption (PSA) unit, a caustic wash, and combinations thereof. The treating units are preferably selected to separate desired gas phase molecules. For example, an amine scrubber is used to selectively separate H₂S and/or carbon oxides from H₂ and/or hydrocarbons. As another example, a PSA unit may be used to purify a hydrogen stream for recycling to a stripper and/or a reactor in the hydrotreating zone 14.

Hydrotreated effluent from one or more reactors in the hydrotreating zone 14 may each be treated in a separate embodiment of the separation zone 20. Effluents from different reactors/zones may be treated in all or some of the same separation units.

A portion of the hydrotreated effluent 16 from one or more separator units may be returned to a hydrotreating zone 14, for example, as a quench stream (not shown) or as a diluent (not shown) of feedstock 12.

The hydrotreated effluent 16 (with or without a separation step) is passed to a hydroisomerization zone 24 under hydroisomerization conditions to cause a hydroisomerization reaction. The hydroisomerization reaction increases branching of the paraffinic compounds resulting from the hydrotreating zone 14, thereby improving the cold flow properties of the fuel.

The hydroisomerization catalyst may be any suitable catalyst composition known to those skilled in the art. Preferably, the hydroisomerization catalyst comprises a Group VIII metal. More preferably, the hydroisomerization catalyst further comprises a zeolitic material. The hydroisomerization catalyst may further comprise a binder and/or carrier, such as, without limitation, silica, alumina, silica-alumina, and combinations thereof. Preferably, the Group VIII metal is selected from the group consisting of platinum, palladium, nickel, and combinations thereof. When the Group VIII metal is Ni, the hydroisomerization preferably includes a Group VI metal, preferably Mo or W.

The zeolitic material is preferably selected from the group consisting of Beta, COK-7, EU-1, EU-2, EU-11, IZM-1, MCM-22, NU-10, ZSM-5, ZSM-12, ZSM-22, ZSM-23, ZSM-30, ZSM-35, ZSM-48, ZSM-50, ZSM-57, and combinations thereof.

The catalyst may be the same or different throughout the hydroisomerization zone 24. The hydroisomerization zone 24 may comprise a single catalyst bed or multiple catalyst beds. The catalyst may be the same throughout the single catalyst bed, optionally there is a mixture of catalysts, or different catalysts may be provided in two or more layers in the catalyst bed. In an embodiment of multiple catalyst beds, the catalyst may be same or different for each catalyst bed.

The hydroisomerization zone 24 is operated in the presence of hydrogen at a pressure in a range of from 1 MPa to 30 MPa and at a temperature in a range of from 260° C. to 400° C. Preferably, the pressure is in a range of from 2 MPa to 17 MPa, and the temperature is in a range of from 300° C. to 380° C. The LHSV is in a range of from 0.2 h⁻¹ to 4 h⁻¹ based on effluent 16. The ratio of the hydrogen gas to the combined liquid supplied to the hydroisomerization zone 24 is in a range of from 100 to 1500 normal L (at standard conditions of 0° C. and 1 atm (0.1 MPa)) per kg of the combined liquid.

Hydroisomerization is particularly advantageous for improving the production of kerosene for jet fuel. To increase kerosene production, the WABT (weighted average bed temperature) in the hydroisomerization zone is typically increased. WABT is a representative temperature, assuming an adiabatic reactor having no loss or gain from its surroundings, for the catalyst bed. Those skilled in that art understand that the temperature profile will typically increase from inlet to outlet.

The hydroisomerization conditions and catalyst are selected to favour branching over cracking. The inventors have surprisingly discovered that by operating at a lower hydroisomerization severity, the yield of heavy fraction is increased, and by passing the heavy fraction to a hydrocracking zone and then isomerizing the hydrocracked effluent, the yield of desirable isomerized product can be increased. The severity of the hydroisomerization zone is influenced by type and amount of catalyst, operating temperature, operating pressure, space velocity, and the like.

An advantage of the present invention is that the degree of hydroisomerization can be less severe, thereby allowing for a lower WABT as compared with conventional processes. Furthermore, a lower WABT allows for lower operating pressure while maintaining same flow regime, thereby providing an improved opportunity to revamp or reuse existing lower pressure petroleum refinery equipment for hydroisomerization.

The product from the hydroisomerization zone 24 is directed to a work-up section. Various embodiments for the work-up section may be considered. For example, the work-up section may be as described in U.S. 63/245,023 or U.S. 63/245,009 filed 2021 Sep. 16, incorporated by reference herein. The work-up section includes one or more product recovery zones 26 resulting in desired product streams. For example, the embodiment of FIG. 1 illustrates an off-gas stream 32, a naphtha boiling point range stream 34, a kerosene boiling point range stream 36, a diesel boiling point range stream 38, and a heavy fraction 42. In this embodiment, the off-gas stream 32 suitably comprises C1-C5 hydrocarbons, while the naphtha boiling point range 34 suitably comprises C4-C12 hydrocarbons in a boiling point range of from −12° C. to 204° C. The kerosene boiling point range stream 36 is preferably comprised of C6-C18 hydrocarbons having a boiling point range of from 90° C. to 300° C. In one embodiment, the diesel boiling point range stream comprises C8-C26 hydrocarbons having a boiling point range of from 120° C. to 400° C. In this embodiment, the heavy fraction 42 has C17+ hydrocarbons having a boiling point greater than 250° C.

As another example, the embodiment of FIG. 2 illustrates an off-gas stream 32, a naphtha boiling point range stream 34, a kerosene boiling point range stream 36, and a heavy fraction 42. In this embodiment, the off-gas stream 32 suitably comprises C1-C5 hydrocarbons, while the naphtha boiling point range 34 suitably comprises C4-C12 hydrocarbons in a boiling point range of from −12° C. to 204° C. The kerosene boiling point range stream 36 is preferably comprised of C6-C18 hydrocarbons having a boiling point range of from 90° C. to 300° C. In this embodiment, the heavy fraction 42 has C17+ hydrocarbons having a boiling point greater than 250° C.

The example product streams illustrated in FIG. 1 may be applied to the process embodiments of FIG. 2 and vice versa.

In a preferred embodiment, the process is directed towards improving the yield of the kerosene boiling point range stream 36. In particular, in a preferred embodiment, the process is directed toward a kerosene product meeting the specifications of ASTM D7566, wherein a synthesized paraffinic kerosene from hydroprocessed esters and fatty acids has a T10 distillation temperature (using ASTM Test Method D86) maximum of 205° C. and a final boiling maximum of 300° C.

In this case, for the FIG. 1 embodiment, at least a portion of the diesel boiling point range stream 38 is recycled with the heavy fraction 42. Another portion of the diesel boiling point range stream 38 may be drawn off as a bleed stream. The product recovery zone 26 may include a further separation of the diesel boiling point range stream 38 into a light diesel stream that may be drawn off as a bleed stream, for example, while the heavy diesel stream is recycled with the heavy fraction 42.

Additionally, or alternatively, the product recovery zone 26 may include a further separation of heavy contaminants from the heavy fraction 42. Depending on the original feedstock and/or processing conditions, it is possible that heavy contaminants are present that may not be reactive in a subsequent hydrocracking and/or hydroisomerization zones. In this case, it is preferred to provide a bleed stream of a heaviest portion of the heavy fraction 42. In one embodiment, the bleed stream has substantially the same composition as the heavy fraction 42. In another embodiment, the bleed stream may be the product of a further treatment and/or separation of the heavy fraction 42 to selectively remove contaminants from the heavy fraction 42.

In the FIG. 2 embodiment, the diesel boiling point range hydrocarbons are part of the heavy fraction 42 and are recycled for cracking and isomerization to extinction.

As noted above, the embodiments of the product recovery zone 26 of FIGS. 1 and 2 may be comprised of one or more unit operations. For example, the product recovery zone 26 may include a product stripper for striping entrained and/or dissolved gases from the hydroisomerizaton zone effluent, a naphtha stripper to produce the stripper offgas stream and a naphtha stream, a naphtha stabilizer column, a naphtha rectification column, a naphtha recovery column, an overhead separator, a vacuum fractionator, an atmospheric fractionator, and combinations thereof.

At least a portion of the heavy fraction 42 is directed to a hydrocracking zone 44 under hydrocracking conditions sufficient to cause a hydrocracking reaction to produce a hydrocracked effluent. In one embodiment, another portion of the heavy fraction 42 may be directed to further processing for valorizing the heavy fraction 42.

The hydrocracking catalyst may be any suitable catalyst composition known to those skilled in the art. Preferably, the hydrocracking catalyst comprises a Group VIII metal. More preferably, the hydrocracking catalyst further comprises an acidic material.

The acidic material may be an amorphous acidic material, a crystalline acidic material, or a combination thereof. The amorphous acidic material may be, for example, without limitation, amorphous silica alumina. The crystalline acidic material may be selected from selected from the group consisting of Beta, COK-7, EU-1, EU-2, EU-11, IZM-1, MCM-22, NU-10, ZSM-5, ZSM-12, ZSM-22, ZSM-23, ZSM-30, ZSM-35, ZSM-48, ZSM-50, ZSM-57, and combinations thereof.

Preferably, the Group VIII metal is selected from the group consisting of platinum, palladium, nickel, and combinations thereof. When the Group VIII metal is Ni, the hydroisomerization catalyst preferably includes a Group VI metal, preferably Mo or W.

The hydrocracking catalyst may further comprise a binder and/or carrier, such as, without limitation, silica, alumina, silica-alumina, and combinations thereof.

The hydrocracking zone 44 is operated in the presence of hydrogen at a pressure in a range of from 1 MPa to 30 MPa and at a temperature in a range of from 260° C. to 400° C. Preferably, the pressure is in a range of from 2 MPa to 18 MPa, and the temperature is in a range of from 280° C. to 400° C.

The hydrocracking conditions and catalyst are selected to favour cracking over branching.

In the embodiment of FIG. 1, the hydrocracking zone 44 is provided in a single-stage configuration above the hydroisomerization zone 24. In this embodiment, the heavy fraction 42 is recycled to a single stage reactor comprising both the hydrocracking zone 44 and a hydroisomerization zone 24. The heavy fraction 42 is first reacted in the hydrocracking zone 44. The hydrocracked effluent from the hydrocracking zone is then passed to the hydroisomerization zone 24 where it is combined with the hydrotreated effluent 16 for isomerizing the hydrocracked effluent and the hydrotreated effluent concurrently.

In the embodiment of FIG. 2, the hydrocracking zone 44 and the hydroisomerization zone 24 are provided in a two-stage configuration. In this embodiment, the heavy fraction 42 is recycled to the hydrocracking zone 44 and a hydroisomerization zone 24. The heavy fraction 42 is first reacted in the hydrocracking zone 44. The hydrocracked effluent from the hydrocracking zone is then passed to the hydroisomerization zone 24 where it is combined with the hydrotreated effluent 16 for isomerizing the hydrocracked effluent and the hydrotreated effluent concurrently.

In each of the embodiments of FIGS. 1 and 2, the hydroisomerization zone 24 optionally includes a hydrofinishing zone (not shown). During the hydroisomerization step and/or depending on the feedstock used (for example, cashew oil), some aromatics and/or trace olefins may be present in the effluent of the hydroisomerization zone. In this case, the hydrofinishing step is preferably provided to reduce the aromatic content of the product stream(s).

The hydrofinishing components may be used in bulk metal form, or the metals may be supported on a carrier. Active metals for hydrogenation include catalytically active metals of Group VIII and/or Group VIB, including, without limitation, Ni, Co, Mo, W, and combinations thereof. Preferably, the Group VIII metal is selected from the group consisting of platinum, palladium, nickel, and combinations thereof. Suitable carriers include refractory oxides. Examples of suitable refractory oxides include, without limitation, alumina, amorphous silica-alumina, titania, silica, and combinations thereof.

In the process of the present invention 10, the amount of recycle for the heavy fraction 42 can be selected to be 20-200 wt. % of the renewable feedstock 12 to the isomerisation bed, preferably in the range of 30-100 wt. % of the renewable feedstock 12.

### EXAMPLES

The following non-limiting examples of embodiments of the method of the present invention as claimed herein are provided for illustrative purposes only.

### Example 1

A catalyst bed consisting of 30 mL of a hydroisomerisation catalyst comprising 0.7 wt. % Pt on a carrier comprising 75 wt. % silica and 25 wt. % zeolite ZSM-12 was placed in a reactor. The catalyst was 1:1.5 diluted with 0.05 mm diameter silicon carbide particles. The silicon carbide particles were applied to mitigate reactor wall effects which could disturb the uniform liquid distribution over the catalyst bed cross section.

The temperature of the bed was controlled by means of an oven. The catalyst bed was operated at a WABT of 320° C. A hydrotreated effluent was supplied to the catalyst bed at a WHSV of 1.0 g fresh liquid per mL catalyst per hour. The hydrotreated liquid was produced by deoxygenating soybean oil. A gas stream comprising 100% vol % hydrogen was supplied to the top bed at a gas-to-oil ratio of 500 NL/kg. The total pressure at the reactor outlet was 73 barg (7.3 MPag).

The degree of conversion of the feedstock was determined in multiple ways. The hydrocarbon liquid was analysed using two-dimensional gas chromatography to determine the molecular composition of the hydrocarbon product in terms of n-paraffinic, i-paraffinic, naphthenic, and aromatic species, as well as by ASTM D2887 simulated distillation to determine the boiling range distribution. The improvement of cold flow properties and density were measured using the ASTM D2500 method.

Prior to hydroisomerization, the hydrotreated liquid had a cold flow property, measured as cloud point, of 27° C. After hydroisomerization, the cloud point was reduced to −7° C., an improvement of 34 Celsius degrees.

The gaseous effluent was analysed using gas chromatography.

The results as measured by two-dimensional gas chromatography are shown in percent weight in Table 1.

The combined yield statement based on the analysis of the gas effluent and the simulated distillation analysis of the hydrocarbon liquid is shown in Table 2.

### Comparative Example 2

Example 1 was repeated three times with increases of the WABT to 330° C., 340° C. and 345° C. as the only change compared to Example 1

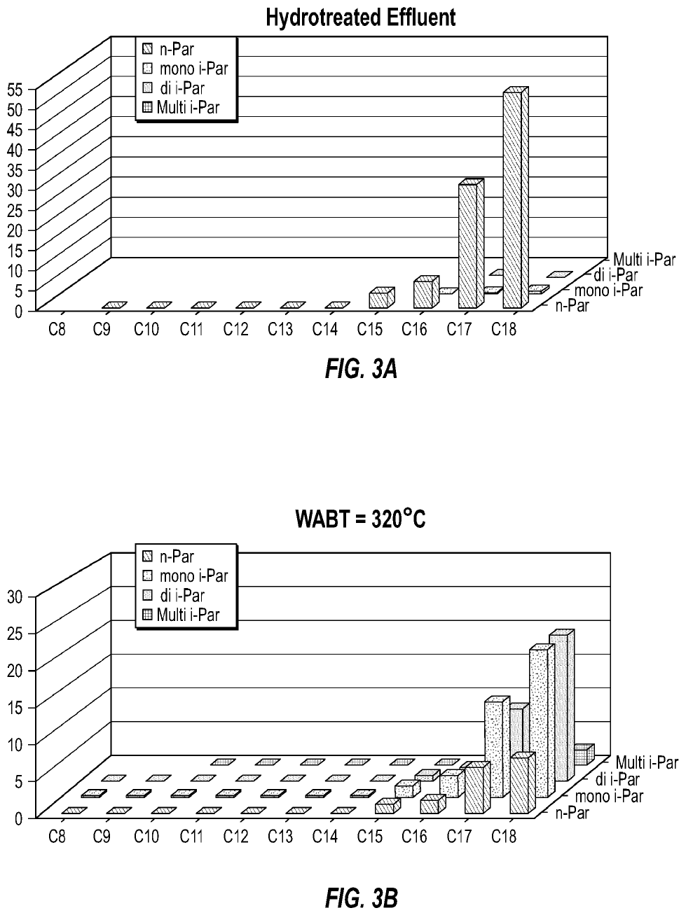

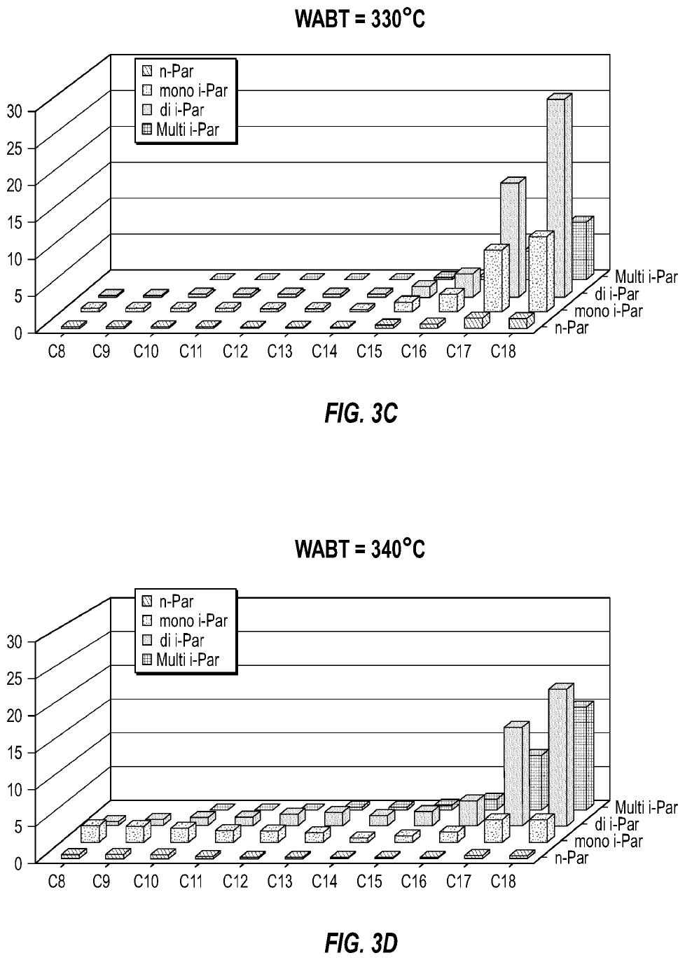

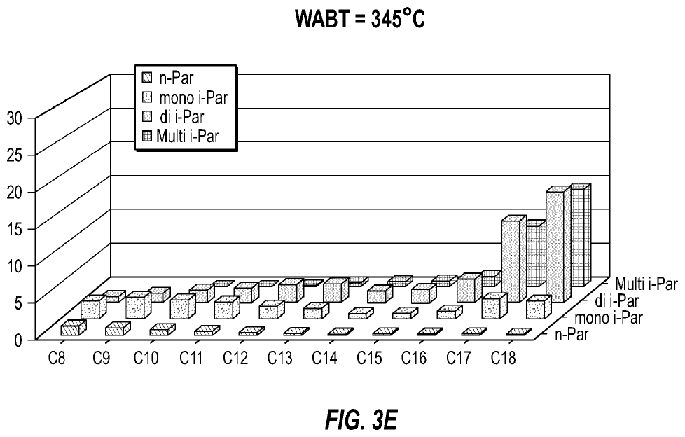

FIGS. 3A-3E illustrate the carbon number distribution of normal-paraffins, mono-branched iso-paraffins, di-branch iso-paraffins, and multi-branched iso-paraffins for the hydrotreated effluent (FIG. 3A), WABT=320° C. (FIG. 3B), WABT=330° C. (FIG. 3C), WABT=340° C. (FIG. 3D), and WABT=345° C. (FIG. 3E).

TABLE 1

| | | Hydroisomerised Effluent | | | |
|---|---|---|---|---|---|
| | Hydrotreated | | Comparative | | |
| Analysis | effluent | Example 1 | Example 2 | | |
| HIS Zone WABT (° C.) | | 320 | 330 | 340 | 345 |
| Cloud point (° C.) | 27 | −7 | −30 | −49 | −53 |
| C₁₅-C₁₈ n-Paraffin | 94.1 | 17.48 | 3.84 | 1.03 | 0.75 |
| compounds (wt. %) | | | | | |
| C₁₅-C₁₈ i-Paraffin | 0.55 | 73.5 | 82.13 | 70.01 | 61.88 |
| compounds (wt. %) | | | | | |
| Naphthenic | 0.72 | 2.21 | 2.17 | 2.27 | 2.25 |
| Compounds (wt. %) | | | | | |
| Lights* (wt. %) | 0.21 | 3.76 | 9.06 | 24.34 | 32.99 |
| Heavies** (wt. %) | 4.41 | 3.06 | 2.79 | 2.35 | 2.13 |

*C₁₄ and lighter compounds
**C₁₉ and heavier compounds

TABLE 2

| | Hydroisomerised Effluent | | | |
|---|---|---|---|---|
| Analysis | Example 1 | Comparative Example 2 | | |
| HIS Zone WABT (° C.) | 320 | 330 | 340 | 345 |
| C₁-C₄ (woff %) | 0.32 | 0.58 | 0.63 | 2.04 |
| C₅-150° C. naphtha (woff %) | 2.77 | 5.96 | 15.09 | 21.43 |
| 150-300° C. kerosene (woff %) | 37.48 | 50.45 | 61.41 | 59.58 |
| 300° C.⁺ gasoil (woff %) | 59.52 | 43.13 | 23.16 | 17.31 |
| Total (woff %) | 100.09 | 100.12 | 100.29 | 100.35 |

where woff is wt. % on fresh feed

Table 1 shows that when the HIS zone temperature is increased, the degree of isomerization of the effluent, reported as the cloud point and the molecular composition measured by two-dimensional gas chromatography, improves. As expected, increased HIS severity improves degree of isomerization.

However, Table 2 shows that more severe operation at increased reactor temperature simultaneously leads to more extensive cracking leading to increased yields of undesired gas and naphtha, while reaching a maximum in the yield of desired kerosene.

It is generally understood that increasing the severity of hydroisomerizaton conditions leads to improved yield of isomerized product. However, there is a concomitant increase in cracking reaction that increases the yield of less valuable and/or undesirable gas and/or naphtha. The inventors surprisingly discovered that by operating at a lower severity (e.g., at mild to moderate hydroisomerization conditions), a higher yield of heavy fraction is produced along with a lower yield of gas and naphtha. In accordance with the present invention, the yield of desired isomerized product is significantly improved by operating at a lower severity HIS zone to intentionally increase the heavy fraction yield, by passing the heavy fraction to a hydrocracking zone to produce a hydrocracked effluent that is then hydroisomerised.

The process of the present invention 10 allows for variability of renewable feedstocks, including a change from one type of feedstock to another, for example, due to supply and/or markets, changes in feedstock quality and/or composition profile, seasonal variations, variations between sources of same feedstock, and the like. The process of the present invention 10 provides flexibility to meet product specifications for diesel and/or kerosene despite resulting changes in reaction schemes, operating conditions, heat generation, process efficiency, product composition, and/or product yield that are impacted by such variability, even with changes in product component yields due to catalyst activity changes, and/or from start-of-run to end-of-run. The process of the present invention 10 provides flexibility and robustness to allow for feedstock variability, changes in catalyst activity, and/or changes in desired products, while reducing energy consumption, operating costs, and/or carbon footprint. Further, the process of the present invention enables revamp of existing process schemes used for processing petroleum-derived feedstock.

While the embodiments are described with reference to various implementations and exploitations, it will be understood that these embodiments are illustrative and that the scope of the inventive subject matter is not limited to them. Many variations, modifications, additions and improvements are possible. Various combinations of the techniques provided herein may be used.

1. A process for improving yield of kerosene and/or diesel from a renewable feedstock, the process comprising the steps of:
reacting a renewable feedstock in a hydrotreating zone under hydrotreating conditions sufficient to cause a hydrotreating reaction to produce a hydrotreated effluent;
reacting the hydrotreated liquid in a hydroisomerization zone under hydroisomerization conditions to cause a hydroisomerization reaction to produce an isomerized effluent;
separating the isomerized effluent to produce an offgas stream, at least one fuel stream having a desired boiling point range, and a heavy fraction having a boiling point greater than the desired boiling point range;
reacting the heavy fraction in a hydrocracking zone under hydrocracking conditions to cause a hydrocracking reaction to produce a hydrocracked effluent; and
passing the hydrocracked effluent to the hydroisomerization zone.

2. The process of claim 1, wherein the at least one fuel stream is selected from the group consisting of a naphtha boiling point range product stream, a kerosene boiling point range product stream, a diesel boiling point range product stream, and combinations thereof.

3. The process of claim 1, wherein the hydroisomerization conditions and hydroisomerizaton catalyst are selected to favour branching over cracking and the hydrocracking conditions and the hydrocracking catalyst are selected to favour cracking over branching.

4. The process of claim 1, wherein the hydroisomerization conditions include a temperature in a range of from 260° C. to 400° C., preferably in a range of from 300° C. to 380° C., and a pressure in a range of from 1 to 30 MPa, preferably in a range of from 2 to 17 MPa.

5. The process of claim 1, wherein the hydroisomerization conditions and hydroisomerization catalyst are selected to operate at a mild or moderate hydroisomerization severity.

6. The process of claim 1, wherein the hydroisomerization step is conducted with a hydroisomerization catalyst comprising a Group VIII metal and a zeolitic material.

7. The process of claim 1, wherein the hydrocracking conditions include a temperature in a range of from 260° C. to 400° C., preferably in a range of from 280° C. to 400° C., and a pressure in a range of from 1 to 30 MPa, preferably in a range of from 2 to 18 MPa.

8. The process of claim 1, wherein the hydrocracking step is conducted with hydrocracking catalyst comprising a Group VIII metal.

9. The process of claim 8, wherein the hydrocracking catalyst further comprises an acidic material.

10. The process of claim 1, wherein the hydrocracking zone and the hydroisomerization zone are arranged in a single reactor in a stacked bed configuration.

11. The process of claim 1, wherein the hydrocracking zone and the hydroisomerization zone are arranged in reactors in series.

12. The process of claim 1, wherein the hydrotreating zone further comprises a separation zone for separating a product of the hydrotreating reaction into a vapor phase effluent and a liquid hydrotreated effluent.

13. The process of claim 1, wherein the renewable feedstock is selected from the group consisting of one or more bio-renewable fats and oils, liquid derived from a biomass liquefaction process, liquid derived from a waste liquefaction process, and combinations thereof.

14. The process of claim 1, further comprising adding a petroleum-derived feedstock for co-processing with the renewable feedstock, preferably in an amount to produce a feed stream comprising from 30 to 99 wt. % renewable feedstock.

15. The process of claim 1, further comprising the step of hydrofinishing the isomerized effluent.
